(19) United States
(12) Patent Application Publication
(10) Pub. No.: US 2009/0075662 A1
(43) Pub. Date: Mar. 19, 2009

(54) Broadband Radio Communications System Including Receiving Station and Optimization of Same

(75) Inventor: Gerard MARQUE-PUCHEU, Verneuil (FR)

Correspondence Address: CROWELL & MORING LLP;INTELLECTUAL PROPERTY GROUP, P.O. BOX 14300, WASHINGTON, DC, 20044-4300, US

(73) Assignee: EADS Secure Networks SAS, Elancourt (FR)

(21) Appl. No.: 12/046,264

(22) Filed: Mar. 11, 2008

(30) Foreign Application Priority Data
Sep. 14, 2007 (FR) 07 06481

(51) Int. Cl. H04Q 7/20; H04Q 7/00

(52) U.S. Cl. 455/445; 455/517; 370/328

(57) ABSTRACT

In a method and apparatus for optimizing a data link between a mobile station and a main base station, the link is formed by an uplink radio signal from the mobile station and a downlink radio signal from the main base station, both of which include frames that carry data and protocol information. A radio receiver of a complementary receiving station has an antenna system for receiving both the downlink radio signal and uplink radio signal. An interface circuit cooperates with a baseband processor for decoding the uplink radio signal based on information obtained from decoding the downlink radio signal. The interface circuit enables establishment of a separate data link between the complementary receiving station and the main base stations, for transmitting information obtained from decoding the uplink radio signal.

### BACKGROUND AND SUMMARY OF THE INVENTION

This application claims the priority of French patent application 07 06481, filed Sep. 14, 2007, the disclosure of which is expressly incorporated by reference herein.

The invention relates to a broadband radio communications system, a complementary receiving station, and a method to optimize the linking budget and the spectral efficiency of a radio communications system. In particular, the invention applies to Land Mobile Radio (LMR) communications.

Land Mobile Radio systems generally comprise a certain number of cells, with each cell including at least one main base station. Within any one cell, mobile stations can exchange data over the air with the corresponding main base station. In general, the transmitting power of mobile stations, typically a few watts for a portable mobile station, is significantly inferior to that of the main base station, which can reach up to several tens of watts. Such asymmetry limits the mobile station's range while it is transmitting.

In order to improve the reception by the main base station of signals transmitted by mobile stations in such systems, voting receivers have been frequently used. These voters are set up in various points in each cell and linked to a central voting site. Each state-of-the-art voting receiver receives signals transmitted by mobile stations over a plurality of channels in one-to-one correspondence with the receiving channels of the main base station, themselves paired to the transmission channels of the main base station. The voting receiver scans radio transmissions on each channel and synchronizes itself with the received data. After being detected, the received data are sent to the central voting site. The central voting site keeps only per channel a single piece of information from the ensemble of data received from the various distributed voting receivers. Use of state-of-the-art voting receivers is, however, ill-adapted to LMR systems, which use radio signals that comply with broad band transmission standards, such as the 802.16e standard as defined by the Institute of Electrical and Electronics Engineers (IEEE).

In systems using radio signals that comply with broad band or very broad band transmission standards, the main base station generally uses only a single channel. Moreover, the modulation and coding structure of the uplink signal (that is the link from the mobile station to the main base station) is variable from frame to frame. Therefore, this structure cannot be correctly demodulated and decoded by prior art receivers, which are incapable of the real-time update necessary to decode such a structure.

Additionally, broad band systems allow services to be offered to users, such as the simultaneous transmission of several video bit streams to a central control site. These services, however, introduce significant asymmetries between the uplink and the downlink in terms of available power density (that is, from the main base station to the mobile station). Such asymmetry generates a critical need for improving the linking budget of the uplink.

To solve this problem at least partially, the 802.16e standard provides for functions that allow the frequencies attributed to transmissions to be fractionally reused. Several mobile stations can thus use the same subcarrier, at the same instant, at different points of the covered area. These transmissions, which are generated by different mobile stations, and are controlled by the main base station, do not interfere with one another when, in particular, the involved mobile stations are at a sufficient distance from each other. In this context, voting receivers cannot take advantage of these possibilities because such transmissions are not subject to the mechanical selection aimed at maintaining a single reception, as voting receivers of the prior art are, and each of the transmissions may include different non redundant data.

A working version of the future 802.16j standard exists also, which defines relays. Relays allow the reduction of uplink transmission losses between mobile stations and the main base station. Each relay includes means for receiving transmissions from the main base station and mobile stations, and includes, additionally, means to retransmit the received data. In order to reduce transmission losses, the following are reserved in the frames exchanged between the relay, the main base station, and the mobile stations:
a first part for transmissions between the main base station and the relay;
a second part for transmissions between the relay and mobile stations;
a third part for transmissions between mobile stations and the relay; and
a fourth part for transmissions between the relay and the main base station.

While the efficiency of this technique is ensured by performing modulations on each segment, a large portion of this gain is lost in the repetition of each piece of information; that is, a first time on the segment between the mobile station and the relay and a second time between the relay and the base station. Moreover, at least on the segment between the base station and the relay, the data concerning each mobile station must be carried on separate areas of the frame, which further reduces the potential for improvement of the spectral efficiency.

The present invention aims to remedy the disadvantages mentioned above. To this effect, the subject of the invention is a method for optimizing a data link between a mobile station and a main base station. The link comprises an uplink radio signal transmitted by the mobile station and a downlink radio signal transmitted by the main base station. The uplink radio signal and the downlink radio signal comprise frames carrying data and protocol information. The method according to the invention includes:
in a first step, receiving the downlink radio signal;
in a second step, receiving the uplink radio signal;
in a third step, decoding data and protocol information in the frames of the downlink radio signal;
in a fourth step, decoding, at least in part, data and protocol information in the frames of the uplink radio signal by means of information resulting from the decoding of the downlink radio signal; and
in a fifth step, transmitting to the main base station the data and protocol information extracted from the decoding completed in the fourth stage.

The uplink radio signal can be carried by a subframe of the uplink and the downlink radio signal can be carried by a subframe of the downlink. The uplink and the downlink subframes can be in compliance with the IEEE 802.16e standard. In an embodiment of the method according to the invention suitable for such signals, following the transmission by the mobile station of a ranging code included in the uplink subframe,
during the first stage, data and protocol information are received, including a downlink preamble and map in the downlink subframe;
during the second stage, the code is received as soon as it is transmitted by the mobile station at the appropriate power level;
during the third stage, data and at least a portion of the protocol information, including the downlink preamble and map in the downlink subframe, are decoded;
during the fourth stage, the code is decoded by means of information obtained from the third stage; and
during the fifth stage, the decoded code is transmitted to the main base station.

In another embodiment of the invention, which is suitable for such signals, during the fifth stage, information is sent to the main base station concerning power that relates to slots in the uplink subframe that are allocated to any mobile station whose uplink radio signal can be received during the second stage.

Another object of the invention is to provide a complementary receiving station for implementing the method according to the invention. The complementary receiving station includes at least one aerial system linked to at least one radio receiver that is suitable for receiving a downlink radio signal transmitted by a main base station, and for receiving an uplink radio signal transmitted by mobile stations. Both the uplink and the downlink radio signals include frames carrying data and protocol information. The complementary receiving station includes an interface circuit that cooperates with a baseband processor suitable for decoding the uplink radio signal with help from the information obtained from the decoding of the downlink radio signal. The interface circuit allows the establishment of a data link with the main base station. The data link is used to transmit information obtained from the decoding of the uplink radio signal.

In the complementary receiving station, both the uplink and the downlink radio signals are in compliance with the IEEE 802.16e standard, as the aerial system, the radio receiver, and the baseband processor are suitable for processing such signals.

Still another subject of the invention is a radio communications system for implementing the method according to the invention, including:
at least one main base station suitable for transmitting over a coverage area of a downlink radio signal;
at least one mobile station suitable for transmitting an uplink radio signal; and
complementary receiving stations according to the invention, distributed throughout the coverage area. Each complementary receiving station has means to receive both the uplink and the downlink radio signals, as well as means to connect to the main base station.

The invention has the particular benefit of allowing the use of complementary receiving stations, the cost of which is significantly lower than the cost of a main base station, due to their reduced size and their low power consumption. Use of these complementary receiving stations translates into significant improvement of both the bit rates available to low power mobile stations and spectral efficiency. Additionally, the invention does not require modification of the mobile stations and does not necessarily require modification of the main base station.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic illustration of an embodiment of a radio communications system according to the invention;

FIG. 2 shows a block diagram of an embodiment of a complementary receiving station according to the invention;

FIG. 3 shows a diagram of the method according to the invention for optimizing a data link between one of the mobile stations and the main base station; and

FIG. 4 shows a schematic representation of an example of frame in a radio signal that complies with the time-division duplex version of the IEEE 802.16e standard.

### DETAILED DESCRIPTION OF THE DRAWINGS

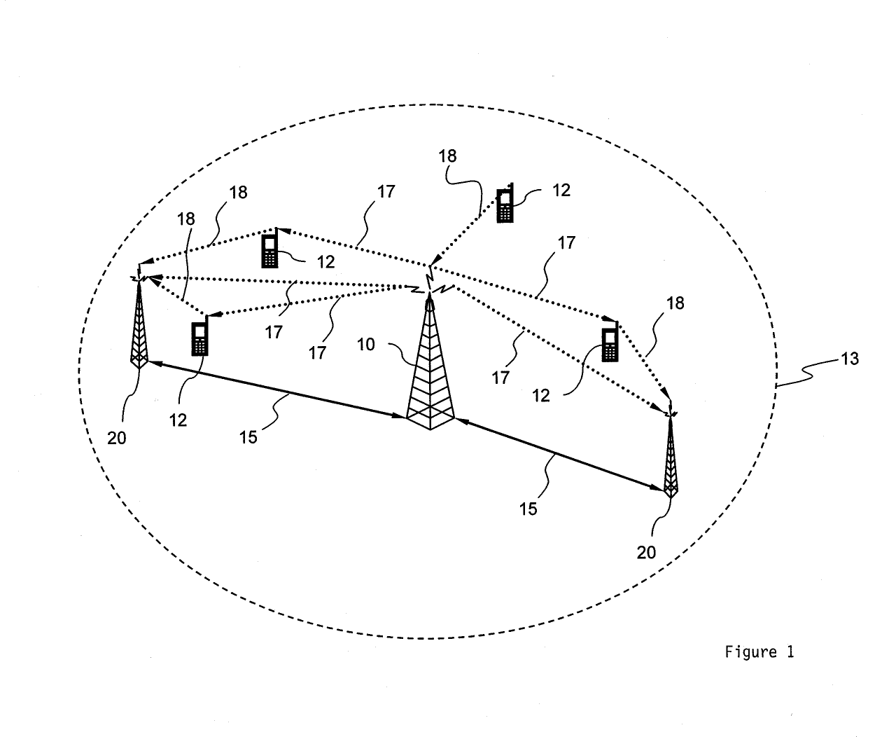

FIG. 1 is a synoptic illustration of a radio communications system which implements the method according to the invention, and which includes at least one main base station 10 that is suitable for transmitting radio signals to mobile stations 12 within a given coverage area 13 (schematically represented by a circle approximately centered on the main base station 10). The main base station 10 can also receive radio signals transmitted by the mobile stations 12. The system of radio communications according to the invention also includes complementary receiving stations 20 that are distributed throughout the coverage area 13. In one embodiment, each complementary receiving station 20 is configured to receive the radio signals transmitted by the main base station 10 and by the mobile stations 12, as well as means to connect to the main base station 10.

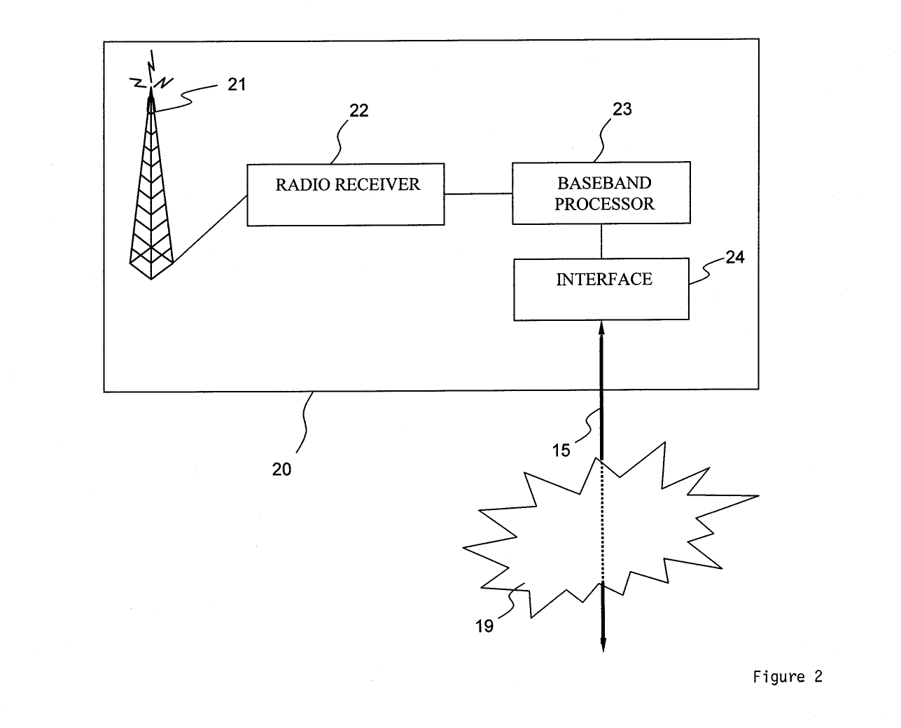

FIG. 2 is a block diagram that illustrates an embodiment of a complementary receiving station 20 according to the invention. Elements already referenced in other figures have the same references. The complementary receiving station 20 is, for example, suitable for receiving a radio signal that complies with the IEEE 802.16e standard, and includes at least one aerial system 21 that is linked to at least one radio receiver 22. The aerial system 21 may include one or more antennae suitable for receiving radio signals, which the radio receiver 22 transforms into digital radio signals. The complementary receiving station 20 also includes a baseband processor 23 that processes the digital signals generated by the radio receiver 22, and may include one or more general purpose processors that are capable of arithmetic computation and/or dedicated processors, such as digital signal type processors (also designated by the English acronym DSP, which stands for “Digital Signal Processor”). The baseband processor 23 may also include means to save into memory the program and intermediate computation data, as well as hardware accelerators, as the case may be.

The complementary receiving station 20 also includes an interface circuit 24 that allows the baseband processor 23 to connect to the main base station 10 through a set up data link 15. The interface circuit 24 may be, for example, an ensemble of network connection means 19 for the transmission and reception of information between the complementary receiving station 20 and the main base station 10.

The network 19 may be, for example, a wire network of a type such as a public network (or WAN according to the English acronym, which stands for “Wide Area Network”) or a federating network (or MAN according to the English acronym, which stands for “Metropolitan Area Network”) that interconnects the main base station 10 and the complementary receiving stations 20. The data link 15 may be, for example, a link supported by the network 19 via optical fibers and appropriate routing equipment.

The network 19 could also be a wireless network that is separate from the mobile network made available to the mobile stations 12 by the base station 10, such as microwave links (point-to-point links); point to multipoint links, such as those which may result from the application of the IEEE 802.16e standard; or else mesh type links (or “MESH” according to the English term) that use different radio protocols in different frequency bands, such as the IEEE 802.11 standard. A combination of these various links is also possible in the context of this invention.

In a second embodiment of the complementary receiving station 20 according to the invention, the complementary receiving station 20 still comprises at least one radio electric transmitter 25 linked to the aerial system 21, and is, for example, suitable for the transmission of a radio signal complying with the IEEE 802.16e standard. The aerial system 21 may comprise one or several antennas suitable for emitting radio electric signals. The radio electric transmitter 22 has in particular the function of transforming the digital signals received by the interface circuit 24 into radio signals. The interface circuit 24 is then used to receive from the main base station 10 the data to be transmitted to the mobile stations 12.

The latter embodiment has the advantage of extending the range while everything else remains the same, and increasing the main base station coverage. Indeed the data link 15 between the main base station 10 and the complementary receiving station 20 including the radio transmitter 25 is used to carry data which may be emitted either by the complementary receiving station 20 only or by the complementary receiving station 20 and the main base station 10 almost simultaneously. The data link 15 used in particular to transfer such data differs from the data link used by the main base station 10 to communicate with the mobile stations 12.

In addition, this embodiment has yet another advantage, in particular with respect to the relays of the IEEE 802.16j standard of the prior art; namely, it avoids repeating all data on the various segments (segment between the mobile station and the relay and between the relay and the base station), and thus avoids the requirement of bringing modifications to the structure of the exchanged frames. Overall, therefore, it improves the spectral efficacy. Additionally, this embodiment allows using low power (typically 5 W) main base stations 10 to complement with less costly complementary receiving stations 20 to cover an area comparable to that covered by more powerful main base stations according to the state of the art (typically 25 W). These complementary receiving stations 20 are suitable, in particular, for broadcasting multimedia content (in particular, video content).

In one embodiment of the radio communications system according to the invention (as presented, for example, in FIG. 1), the main base station 10 transmits a broad band downlink radio signal 17 (for example, a signal that complies with the IEEE 802.16e standard) to the mobile stations 12, in accordance with the IEEE 802.16e standard, and to complementary receiving stations 20. When the radio communications system according to the invention comprises one more complementary receiving stations 20 according to the second embodiment, that is, complementary receiving stations 20 comprising the radio electric transmitter 25, the latter stations 20 may transmit the downlink radio electric signal 17, either instead of the main base station 10 or substantially simultaneously. To that effect, the main base station 10 transmits continuously to the complementary receiving stations comprising the transmitter 25, the data to be transmitted which are included in the downlink radio electric signal 17 via the data link 15. The downlink radio signal 17 includes frames carrying data and protocol information. The mobile stations 12 transmit an uplink radio signal 18 (for example, a radio signal that complies with the IEEE 802.16e standard), including frames carrying data and protocol information.

The uplink radio signal 18 transmitted by the mobile stations can be received directly by the main base station 10 and/or by at least one of the complementary receiving stations 20 according to the invention. When a complementary receiving station 20 receives the uplink radio signal 18, it demodulates and decodes the downlink radio signal 17. Thereafter, it demodulates and decodes the uplink radio signal 18 with information obtained from the decoding of the downlink radio signal 17. The results obtained by the complementary receiving station 20 following the demodulating and decoding of the uplink radio signal 18 are then transmitted by the data link 15 to the main base station 10.

Because the complementary receiving station 20 is, in general, closer to the mobile station 12 than is the main base station 10, there are fewer losses associated with the transmission of the uplink radio signal 18. This reduction in transmission losses is accompanied by other benefits. The coverage of the overall radio communications system is enhanced when compared with the systems known to a person skilled in the art, especially when the mobile stations 1 have only weak radio power available to them. The transmission power required for the ensemble of the mobile stations 1 is lower, including for the mobile stations 12 under coverage of the main base station 10. Because the required transmission power is lower and, in cooperation with the power control mechanisms provided for in the IEEE 802.16e standard, interferences generated by the various mobile stations 12 are weaker, the transmission power the mobile stations 12 require to overcome interferences is further reduced.

In an embodiment of the communication system and the complementary receiving stations 20 according to the invention, the uplink radio signal 18 and the downlink radio signal 17 comply with the IEEE 802.16e standard. Consequently, each complementary receiving station 20 includes apparatus to demodulate and decode the frames of the uplink radio signal 18 that comply with the IEEE 802.16e standard. In particular, the aerial system 21, the radio receiver 22, the baseband processor 23 and the optional radio transmitter 25 are suitable for processing both the uplink radio signals 18 and the downlink radio signals 17 that comply with the IEEE 802.16e standard.

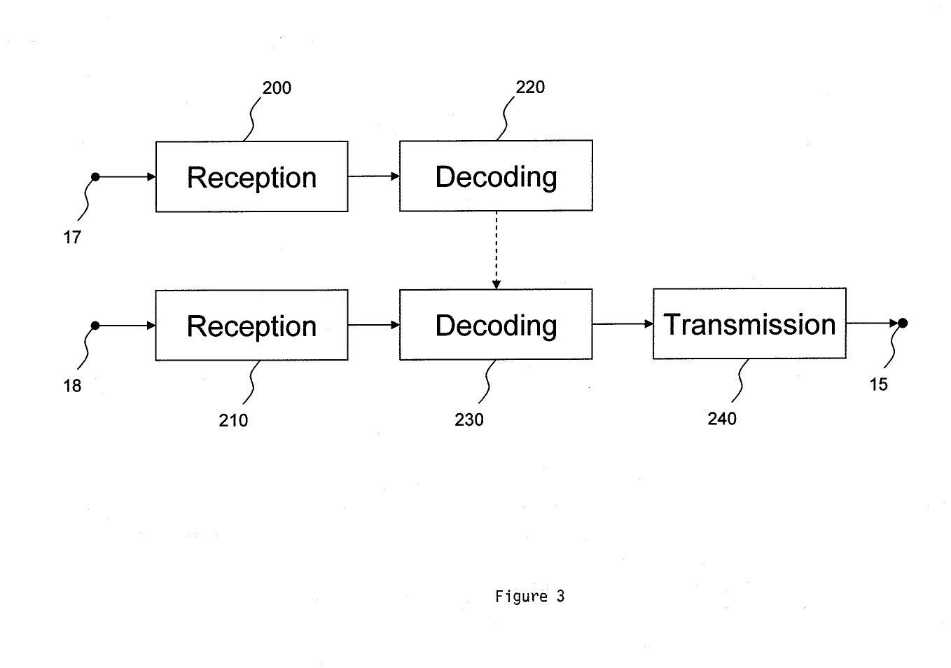

FIG. 3 is a synoptic illustration of an embodiment of the method according to the invention for optimizing a data link between one of the mobile stations 12 and the main base station 10, with the link made up by the uplink radio signal 18 transmitted by the mobile station 12 and the downlink radio signal 17 transmitted by the main base station 10. Elements that are already referenced on other figures have the same references. The method according to the invention can be implemented by the complementary receiving stations 20 according to the invention, including the radio transmitter or not. The method comprises a first step 200 in which the downlink radio signal 17 transmitted by the main base station 10 is received. (If the station includes a radio transmitter 25, it transmits the radio signal 17.) In a second step 210, the uplink radio signal 18 transmitted by the mobile station 12 is received, and in a third step 220, the frame data and protocol information of the downlink radio signal 17 are decoded. In a fourth step 230, the frame data and protocol information of the uplink radio signal 18 are decoded with information generated from the decoding of the downlink radio signal 17 in the third step 220.

The decoding of radio signals allows, in particular, identification and reading of the data included in the frames of the radio signals that relate to the mobile station 12. The decoding relates, in particular, to the data transmitted by the mobile station 12 and the protocol information of the transmission protocol used in the frames of the uplink radio signal 18 and the downlink radio signal 17. The protocol information may be data concerning synchronizing, the distribution of information in each frame, or specific information about transmission parameters; however, it differs from the signaling protocols used in a system such as that according to the invention.

A signaling protocol is understood to be a protocol used, for example, to set up calls. The information of signaling protocols is included, in particular, in the data of the exchanged frames. Then, the information obtained from the decoding in the fourth step 230, as well as the information specific to the mobile station 12, are transmitted to the main base station 10 via the data link 15 in a fifth step 240. During the fifth step 240, the data transmitted are neither carried nor included in the signaling protocol of the main base station 10. (This is also true when the data link 15 is a radio link.) The main base station 10 can then take into account the information received upon completion of the fifth step 240 and transmit, if necessary, to the mobile station 12. The main base station 10 does not, however, implement functions comparable to those that would be implemented by a voting receiver according to prior art.

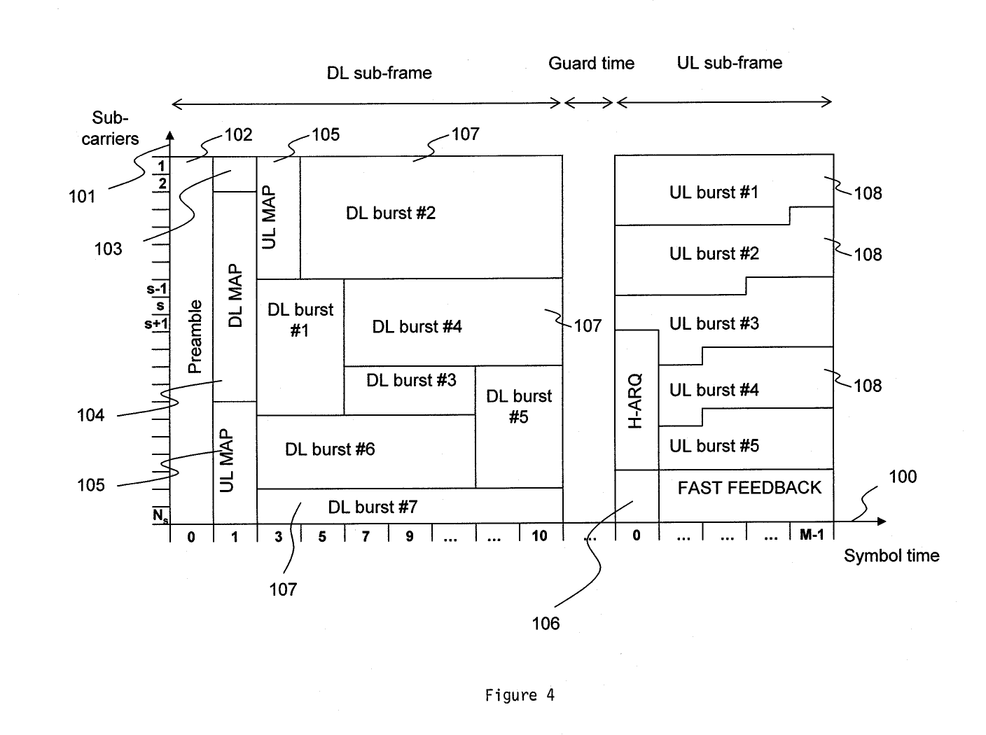

FIG. 4 is a diagram of an example of frame of a radio signal that complies with the IEEE 802.16e standard in its time-division duplex version (or “TDD,” standing for the English expression “Time Division Duplex”). The diagram includes a horizontal axis 100 that represents time intervals and a vertical axis 101 that illustrates the various subcarriers identified by a logical number N. The frame represented in FIG. 4 is decomposed into a downlink subframe extending over a given number of time intervals corresponding to a given integer (ten, in FIG. 4), a gap interval, and then an uplink subframe extending over a number of time intervals represented by an integer M. In the system according to the invention, the downlink subframe typically corresponds to information included in the downlink radio signal 17 that is transmitted by the main base station 10 to the mobile stations 12 and the complementary receiving stations 20. Similarly, the uplink subframe typically corresponds to information included in the uplink radio signal 18 that is transmitted by the mobile stations 12.

The downlink subframe includes, counting from the first time interval, a preamble 102. The latter in turn includes information necessary for the synchronization of the mobile stations 1 and identification of the subcarriers on which other information concerning the use of the air interface will be transmitted. The downlink subframe also includes a control header 103 (generally designated by the English acronym “FCH,” which stands for “Frame Control Header), a downlink map 104 (generally designated by the English acronym “DL MAP,” which stands for “Downlink Map”) and an uplink map 105 (generally designated by the English acronym “UL MAP,” which stands for “Uplink Map”). The control header 103 includes information that is indispensable for decoding the downlink map 104 and the uplink map 105, in particular information relating to modulating and coding. The downlink map 104 includes information concerning the modulating, the coding and the recipient of the information that is included in the downlink bursts 107, themselves included at the end of the downlink subframe. For example, the downlink map 104 includes modulating and coding information used for transmitting the first, second and third downlink bursts 107, etc., as well as the identifiers of the mobile station 1 that are the recipients of the information included in the first, second, and third downlink bursts 107, etc. The uplink map 105 includes information relating to the assignment, modulating, and coding of information included in the uplink bursts 108, themselves included at the end of the uplink subframe. For example, the uplink map 105 includes the identifiers of the mobile stations 1 that will be able to transmit information included in the first, second and third uplink bursts 108, etc., as well as modulating and coding information that the mobile stations 12 must use to transmit the first, second and third uplink bursts 108, etc. In addition to the uplink bursts 108, the uplink subframe includes a ranging zone 106 (generally designated by the English term “Ranging”). The ranging zone 106 is used initially by the mobile stations 12 to signal their presence and then to periodically update the distance information between the mobile station 12 and the main base station 10. The uplink subframe includes other areas, such as an acknowledgement area (generally designated by the English acronym “ACK-CH,” which stands for “Acknowledgement Channel”) and an area for rapid feedback information (generally designated by the English term “Fast-feedback Channel”).

In the system according to the invention with complementary receiving stations 20 that comply with the IEEE 802.16e standard, when one of the mobile stations 12 seeks to enter into the system, it exchanges information with the main base station 10 and, possibly, with one or several complementary receiving stations 20. When any one of the mobile stations 12 wishes to log-in to the system according to the invention, on powering up, for example, said mobile station 12 being synchronizing, first listens to the preamble 102 included in the downlink subframe that is sent by the main base station 10, and then receives the information included on the downlink map 104, useful for determining the main characteristics included in the downlink signal carried by a portion of the downlink bursts 107. The downlink signal includes, in particular, information periodically broadcast in descriptors of the downlink (generally designated by the English acronym “DCD,” which stands for “Downlink Channel Descriptor”) and in descriptors of the uplink (generally designated by the English acronym “UCD,” which stands for “Uplink Channel Descriptor”). The mobile station 12 transmits a code in the ranging zone 106 of the uplink subframe. The code is chosen, in particular, thanks to information broadcast in the downlink descriptor. The code transmission is initially achieved under the lowest transmission power particular to said mobile station 12.

If the mobile station 12 is close to the main base station 10, and should the main base station not receive the code correctly, the code is then transmitted as many times as necessary, with the transmission power being increased with each iteration, until the main base station 10 receives the code correctly or until maximum transmission power is reached. Once the code has been received, the main base station 10 transmits a response message (generally designated by the English acronym “RNG-RSP,” which stands for “Ranging Response”) that signals the moment transmission was successful and the code was used. The ranging response message also includes information that allows the mobile station 12 to regulate its transmission power, generally at the minimum level possible while assuring sufficient service quality and minimizing generated interferences, as well as its clock fine characteristics. The ensemble of these exchanges must be implemented periodically according to the 802.16e standard, that is, not only at the time of the initial entry of said mobile station 12 into the network, but also periodically in order to maintain accurate knowledge of the radio characteristics of the downlink radio signal 17 and the uplink radio signal 18 (a mechanism generally designated by the English expression “Periodic Ranging”).

If the mobile station 12 is close to one of the complementary receiving stations 20, and should the complementary receiving station 20 not receive the code correctly, the code is then transmitted as many times as necessary, with the transmission power increased with each iteration until said complementary receiving station 20 receives the code correctly. The reception of this code by one of the complementary receiving stations 20 is made possible by the fact that such a station is configured to continuously receive and decode the downlink subframe of the downlink radio signal 17. Thus, by processing the decoding and demodulating of the downlink subframe included in the downlink radio signal 17, such processing being achieved in particular with the baseband processor 23, the complementary receiving station 20 can benefit from the same synchronization as the mobile station 11. Similarly, as a result of the decoding of uplink map 105, the complementary receiving station 20 knows the location of the ranging area 106 in the uplink subframe, and can consequently decode the codes of the ranging zone 106 that are included in the uplink subframe. When the complementary receiving station 20 has successfully decoded the codes in the ranging zone 106, it transmits the code in a message to the main base station 10 via its interface circuit 24. The main base station can then verify the possible existence of several copies of this code. Then it transmits a response message (generally designated by the English acronym “RNG-RSP,” which stands for “Ranging Response”) as if it had itself received the code in question; it saves in memory information relative to the complementary receiving station that received the best copy of the code, as well as those stations that received it at various quality levels and that might thus be concerned and/or interfered by later transmissions from the same mobile station 12.

Subsequently, the complementary receiving station 20 receives information sent on the downlink radio signal 17 and can thus receive identifiers that allow recognition of the mobile station 12 to which the messages are sent, in particular allocation messages of the uplink map 105 transmitted by the main base station 10. It should be noted that the method implemented by the main base station 10 that generates these allocation messages can make use of information collected during the decoding stages of the ranging zones described above, in particular information concerning reception quality and potential interferences.

Should one of the mobile stations 12 remain silent for a given period of time, the periodic transmission of code in the ranging zone 106 of the uplink subframe will then allow the periodic update of information concerning the power level at which the uplink radio signal 18 transmitted by said mobile station 12 is received by the various complementary receiving stations 20. Additionally, the various complementary receiving stations 20 and the main base station 10 can maintain an updated listing of the identifiers used by the mobile stations 12, as well as the locations of the mobile stations 12 (which complementary receiving station receives the best quality signal) and potential interferences (ranging codes received by complementary receiving stations other than that with the best quality signal).

In a particular embodiment of the method according to the invention illustrated below, when one of the mobile stations 12 wishes to register or communicate and reinitialize its transmission ranging information with a system according to the invention, and the mobile station is located near one of the complementary receivers 20 that implements the method according to the invention, during the first stage 200, data and protocol information transmitted by the main base station 10 over the downlink radio signal 17 are received, in particular the preamble 102 included in the downlink subframe and the downlink map 104.

During the third step 220, data and protocol information of the frames of the downlink radio signal 17 are then decoded, in particular the preamble 102 and the uplink map 105. As soon as the transmission power needed by the mobile station 12 to transmit a code in the ranging area 106 of the uplink subframe is sufficient, the code is received during the second stage 210, and is decoded with synchronization information obtained after the decoding of the preamble 102 in the third stage 220. The position of the ranging zone 106 obtained from decoding the uplink map 105. The decoded code thus obtained is transmitted to the main base station 10 in the fifth step 240.

In a system according to the invention that includes complementary receiving stations 20 according to the invention that comply with the IEEE 802.16e standard, the main base station 10 transmits the uplink map 105 in the downlink subframe. The uplink map 105, which includes interval allocated in the uplink subframe for each mobile station 12, is used, in particular, by the mobile stations 12 to transmit information. In the system according to the invention, the complementary receiving station 20 according to the invention has means (in particular the baseband processor 23), necessary to decode the uplink map 105, which thus allows it to know which intervals in the uplink subframe are allocated to the mobile stations 12 that are close to said complementary receiving station 20. The complementary receiving station 20 can thus prepare itself for receiving and decoding transmissions from the nearby mobile stations 12. Once the uplink map 105 has been decoded and the mobile station 12 transmissions have been completed, the corresponding information is sent to the main base station 10 via the interface circuit 24. The main base station 10 can then implement the response protocol over the downlink radio signal response 17 in the conditions provided for in the standard.

Each complementary receiving station 20 can also send power information, and if necessary, quality information related to the intervals in the uplink subframe that are attributed to mobile stations 12 not taken into consideration by said complementary receiving station 20. The main base station 10 can thus enhance the interference that each mobile station 12 produced upon other complementary receiving stations 20. The main base station 10 can also dynamically modify, if necessary, a list of the locations of the mobile stations 12 in order to take into account movements of the mobile stations 10 that may not have been correctly detected by means of the initial or periodic code reception in the ranging area 106 of the uplink subframe that was transmitted by said mobile station, and in order to use the network 19 to direct this information to the complementary receiving stations 20.

In a special embodiment of the method according to the invention, during the fifth step 240, information is sent to the main base station 10 concerning power and, as the case may be, quality that relates to the intervals in the uplink subframe that are attributed to the mobile stations 12, the uplink radio signal 18 of which may be received during the second step 210.

In the system according to the invention, the main base station 10 uses the location listing of the mobile stations 12 to improve the global spectral efficiency of the system according to the invention. The main base station 10 can determine, thanks to the result of the initial or periodic reception of the code in the ranging zone 106 of the uplink subframe, both the complementary receiving station best suited to receive communications from a mobile station 12 and the listing of the complementary receiving stations 20 likely to be affected by interferences from said mobile station 12 when the latter is transmitting. In these circumstances, the main base station 10 can assign, to two separate mobile stations 12, two time and/or frequency allocations that are partially or totally overlapping, as long as the corresponding complementary receiving stations 20 are not affected by interferences from both mobile stations 12. Such a hypothetical situation may occur, for example, when the transmission completed by one of the mobile stations 12 is sufficiently mitigated by the propagation or protected by masking so as to not generate any interferences harmful for the complementary receiving stations 20 that do not deal with said mobile station 12. This mechanism allows repeated use of the same frequency subcarriers at the same time and at several locations in the system according to the invention. In this particular embodiment of the system according to the invention, the use of complementary receiving stations 20 with a radio electric transmitter 25 is particularly advantageous, because it allows the optimization of the coverage of the system when regulations severely limit the transmitting power of base stations.

This description relates to a system whose radio signals are in compliance with the time-division duplex version of the IEEE 802.16e standard. However, a person skilled in the art could, from his/her general background and from documents at his/her disposal that discuss examples of broadband networks, implement the system according to the invention in compliance with the IEEE 802.16e standard in its frequency-division duplex (FDD) version (or, according to the English acronym, “FDD,” which stands for “Frequency Division Duplex”).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for optimizing a data link between a mobile station and a main base station, with the link being generated by an uplink radio signal transmitted by the mobile station and a downlink radio signal transmitted by the main base station, and with the uplink radio signal and the downlink radio signals including frames that carry data and protocol information, said method comprising:
in a first step, receiving the downlink radio signal;
in a second step, receiving the uplink radio signal;
in a third step, decoding the data and protocol information contained in frames of the downlink radio signal;
in a fourth step, decoding at least a portion of the frame data and protocol information contained in the uplink radio signal, using information obtained from decoding the downlink radio signal; and
in a fifth step, transmitting to the main base station data and protocol information that is extracted after completing the fourth step decoding.

2. The method according to claim 1, wherein:
the uplink radio signal is carried by an uplink subframe;
the downlink radio signal is carried by a downlink subframe; and
the uplink subframe and the downlink subframe comply with the 802.16e standard of the “Institute of Electrical and Electronics Engineers.”

3. The method according to claim 2, further comprising, following transmission by the mobile station of a code in a ranging zone included in the uplink subframe:
during the first step, data and protocol information are received, including a preamble and a downlink map, that are included in the downlink subframe;
during the second step, the code is received as soon as it is transmitted at a sufficient power level by the mobile station;
during the third step, the data and at least a portion of the protocol information, including the preamble and the downlink map of the downlink subframe, are decoded;
during the fourth step, the code is decoded using information obtained during the third step; and
during the fifth step, the decoded code is transmitted to the main base station.

4. The method according to claim 2, wherein, during the fifth step, power information relating to intervals included in the uplink subframe and allocated to all mobile stations whose the uplink radio electric signal may be received during the second step, is transmitted to the main base station.

5. A complementary receiving station for implementing a method for optimizing a data link between a mobile station and a main base station, with the link being generated by an uplink radio signal transmitted by the mobile station and a downlink radio signal transmitted by the main base station, said complementary receiving station comprising:
at least one radio receiver that is coupled to an aerial system, and is configured for receiving said downlink radio signal transmitted by said main base station and for receiving said uplink radio signal transmitted by said at least one mobile station; and
an interface circuit that cooperates with a baseband processor suitable for decoding the uplink radio signal from information obtained from the decoding of the downlink radio signal; wherein, the uplink radio signal and the downlink radio signal include frames that carry data and protocol information;
the interface circuit enables establishment of a data link between said complementary receiving station and said main base station; and
said data link is used to transmit the information obtained from the decoding of the uplink radio signal.

6. A complementary receiving station according to claim 5, wherein:
the uplink radio signal and the downlink radio signal comply with the 802.16e standard of the “Institute of Electrical and Electronics Engineers;” and the aerial system, the radio electric receiver, and the baseband processor are configured for the processing of such signals.

7. A radio communications system for optimizing a data link between a mobile station and a main base station, with the link being generated by an uplink radio signal transmitted by the mobile station and a downlink radio signal transmitted by the main base station said radio communications system comprising:
at least one main base station that is configured for transmitting over a coverage area of said downlink radio electric signal;
at least one mobile station that is suitable for transmitting said uplink radio signal; and
complementary receiving stations distributed throughout the coverage area; wherein, each complementary receiving station comprises,
at least one radio receiver that is coupled to an aerial system, and is configured for receiving said downlink radio electric signal transmitted by said main base station and for receiving said uplink radio signal transmitted by said at least one mobile stations; and
an interface circuit that cooperates with a baseband processor suitable for decoding the uplink radio signal from information obtained from the decoding of the downlink radio signal; wherein, the uplink radio signal and the downlink radio signal include frames that carry data and protocol information;
the interface circuit enables establishment of a data link between said complementary receiving station and said main base station; and
said data link is used to transmit the information obtained from the decoding of the uplink radio signal.

8. The method according to claim 1, wherein said fifth step includes transmitting said data and protocol information to said main base station via an additional communication link, between said complementary receiving station and said main base, which additional communication link is separate from said data link between the mobile station and the main base station.

9. The method according to claim 3, wherein said fifth step includes transmitting said decoded code to said main base station via an additional communication link between said complementary receiving station and said main base, which additional communication link is separate from said data link between the mobile station and the main base station.

10. The method according to claim 5, wherein said data link between said complementary receiving station and said main base, is separate from said data link between the mobile station and the main base station.
